(19) United States
(12) Patent Application Publication
(10) Pub. No.: US 2007/0208536 A1
(43) Pub. Date: Sep. 6, 2007

(54) Methods and systems for self-improvement

(76) Inventors: Donald Spector, New York, NY (US); Barbara E. Carver, New York, NY (US)

Correspondence Address: Glen M. Diehl;DIEHL SERVILLA LLC, Suite 110, 77 Brant Ave., Clark, NJ, 07066, US

(21) Appl. No.: 11/366,731

(22) Filed: Mar. 2, 2006

(51) Int. Cl. G06F 17/18

(52) U.S. Cl. 702/182; 702/179; 702/127; 702/189

(57) ABSTRACT

A system and method of assessing an individual's chance for success is disclosed. The method includes taking a test, the test including questions that measure a plurality of characteristics of the individual. A score associated with each of the measured plurality of characteristics of the individual in accordance with the pre-selected field is weighted. Then a final score is determined from the weighted scores, the score being indicative of the chance for success in the pre-selected field.

### BACKGROUND OF THE INVENTION

This patent relates to an area of self-improvement assessment. It provides methods and systems for self-improvement.

There are many people that have never been taught skills needed for success in today's world. This is true whether that success is measured in monetary terms or in terms of personal satisfaction. These individuals would derive tremendous benefit from self-improvement curriculums that teach some of the skills needed for success. The individuals who would benefit from such curriculums range from those individuals who have never really entered the job market and whose self-esteem is non-existent to those individuals who have steadily climbed the ladder but are missing a key ingredient to climb to the next rung on the ladder.

An integral part of such a self-improvement curriculum should be a system and method for measuring and determining the amount of improvement. Such a system should allow individuals taking courses in the curriculum to determine their self-improvement, but should also allow third parties, such as a school or an employer, to determine the level of improvement.

Accordingly, new and improved self-improvement curriculums, as well as systems and methods for assessing progress and improvement that result from taking courses in the self-improvement curriculums, are needed.

### SUMMARY OF THE INVENTION

Unlike regular assessments, the model of the present invention breaks out factors that can lead to success into its most elementary formats or the molecules of success. Hundreds of factors in which people make instant judgments are defined and weighted. If someone were to score a zero on this test, the chances of success would be virtually impossible, conversely a score of 100 would ALMOST make it impossible for that person not to succeed. There is always an element of chance. A person with no ability or a zero score could possible inherit money or win a lottery ticket. These scales are based on what we believe is the probability of success, which raises with a high number and drops with a small number.

Unlike other self-help assessments and books, the molecular model of the present invention is unique in that it can give a person instant things that the person can do to improve their score, and while success may be measurable over a longer period of time, the individual components can be used to give a higher score that will ultimately improve the chance for success.

Therefore teeth whitening might be very low on the scale, but it can in a small bit raise your score. This coupled with improving attire and working on speech, can give a person enough to possibly succeed at a job interview (all other factors being equal).

What can clearly be seen from the molecular model of success of the present invention is that there are certain factors that cannot be changed. Therefore, a person must work on those factors that can be changed. A person who is short can wear elevated shoes, since it is believed that height (however small or large) is a factor in success. Also these factors and scales can change based on a person's objectives. A model has a lower weighting for intelligence than a physics professor. Conversely, looks would have a very high rating for the model. It is interesting to note that when talking pictures came in, a lot of silent stars immediately faded because a major new factor was introduced. Conversely, Richard Burton may not have had the molecules for success in the silent age. It is interesting to note that some did make the transition since there are factors beyond the most obvious that include drive, ambition, personality, the undefined charisma, etc.

In accordance with one aspect of the present invention, a method of assessing an individual's chance for success in a pre-selected field includes taking a test that includes questions that measure a plurality of characteristics of the individual, weighting a score associated with each of the measured plurality of characteristics of the individual in accordance with the pre-selected field, and determining a final score from the weighted scores, the score being indicative of the chance for success in the pre-selected field. In accordance with a further aspect of the present invention, the plurality of characteristics of the individual includes one or more physical characteristics of the individual, one or more mental characteristics of the individual and one or more emotional characteristics of the individual.

The method of the present invention can further include determining and weighting a score based on the one or more physical characteristics, determining and weighting a score based on the one or more mental characteristics, determining and weighting a score based on the one or more emotional characteristics and determining the final score from the weighted score based on physical characteristics, the weighted score from the mental characteristics and the weighted score from the emotional characteristics.

The weights used during the weighting steps are determined in accordance with the pre-selected field.

In accordance with a further aspect of the present invention, a self-improvement plan is developed on a computer based on the score associated with each of the measured plurality of characteristics of the individual in accordance with the pre-selected field and on the final score.

The present invention also includes a system of assessing an individual's chance for success in a pre-selected field. The system includes a network, a client computer connected to the network, and a server connected to the network.

Each of the client processors includes computer readable code capable of: providing a test that includes questions that measure a plurality of characteristics of the individual and sending the results of the test to the network. The test itself may reside on the client computer and be run on command from a user, or the test may reside on the server and be downloaded to the client computer on command from a user.

The server receives the results of the test over the network. The server includes computer readable code capable of: weighting a score associated with each of the measured plurality of characteristics of the individual in accordance with the pre-selected field and determining a final score from the weighted scores, the score being indicative of the chance for success in the pre-selected field.

The system can also be implemented on a stand-alone personal computer or other type of computing device such as a personal digital assistant. In this case, the functions implemented by the server and the client computer are combined into computer readable code on the personal computer.

### DESCRIPTION OF THE DRAWINGS

FIG. 1 illustrates a process in accordance with one aspect of the present invention.

FIG. 2 illustrates a process in accordance with another aspect of the present invention.

FIG. 3 illustrates a self-improvement program generated by the system of the present invention.

FIG. 4 illustrates a system in accordance with a further aspect of the present invention.

### DESCRIPTION OF A PREFERRED EMBODIMENT

The present invention provides methods and systems for assessing the chance of an individual succeeding in a selected field and for providing a self-improvement plan or plans to the assessed individual.

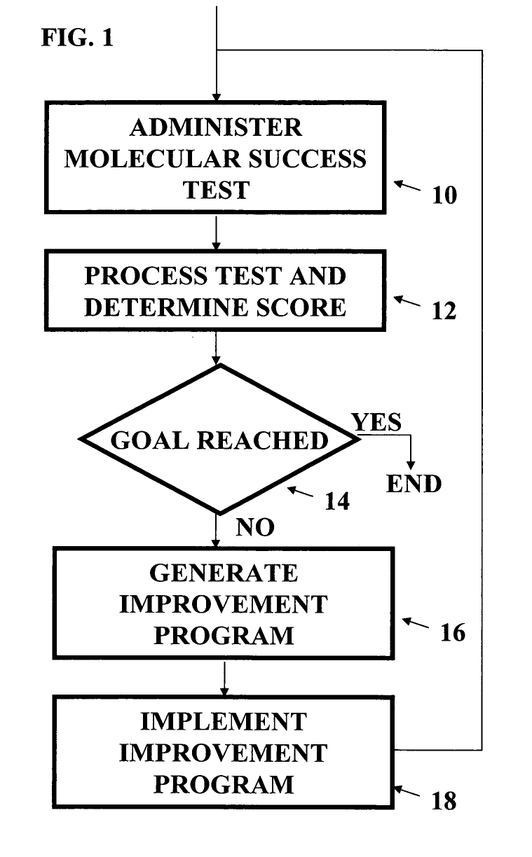

FIG. 1 illustrates a process in accordance with one aspect of the present invention. In step 10, a molecular success test is administered to a person, as described later. In step 12, the test is evaluated and scored. In step 14, it is determined whether a goal has been reached. If this is the first time taking the test, this step is skipped. If the goal has been reached, then the process stops. If the goal has not been reached, then in step 16, an improvement program is generated. In step 18, the improvement program is implemented and eventually the user retakes the test, receives a new score and determines whether the goal has been met.

A number of physical, mental and emotional factors are preferably included in the model or the molecular stress test. The following list includes a template to illustrate the methods and the systems of the present invention, but is not meant to limit the model. The lists will be defined using psychologists, psychiatrists, human resource professionals, executives and others, along with rating scales based on a person's objectives. It is believed that this novel scale, is a unique way of visualizing the area.

Examples of the Molecular Success Traits used in accordance with one aspect of the present invention, are set forth below in Tables 1, 2 and 3 below. Table 1 is illustrative of the physical parameters used in accordance with one aspect of the present invention.

TABLE 1
Physical Parameters
Physical

```
Weight
Height
Torso shape
Face shape
Ears and nose size
Head size
Hair style
Hair length
Hair color
Comb-over
Facial Hair
Color of Eyes
Shape of eyes
Appearance
Skin condition
Facial imperfections
Make-up
Five o'clock shadow
Tan
Body odor
Fragrance
Dress
Fashion sense
Use of color
Fashion color
Fashion fit
Clothing neatness/cleanliness
Appropriate clothing/dress for situation
Appropriate fit
Shoes
Personal accessories
Jewelry/watch
Business accessories
  Briefcase
  Pen
Best colors for skin and hair tone
Tooth health
Breath
Teeth whiteness
Smile
Best smile
Best profile
Hands - size and skin
Nails well groomed
Bitten nails
Speech (articulation)
Speech (modulation)
Grammar
Vocabulary
Listening skills
Eye contact
Firm Handshake
Mannerisms
Manners
  Business
  Personal
Sex Appeal
Physical Fitness
Controlled Breathing
Toned
Health
Dependence on medication
Use of vitamins and supplements
Appearance of Health
Financial Stability
Cultural Background
Educational Background
Previous work experience
Wearing Glasses
Style of glasses
Stride
Walking rhythm
Ability to cut across religious backgrounds
Race
Creed
Diet
Nutrition
Alcohol usage
Drug usage
Smoking
Posture
Sitting position
Foot position
Leg crossing
First impression on others
“Tells” - nervous habits
Strength
  Physical
  Speech
Note taker
Book reader
Legible handwriting
Moist skin
Photogenic
Ability with electronics
Phone manner
Gum chewing
Email style
Business presentation skills
Public speaking skills/style
Swearing
Racial/ethnic slurs
Eating habits
      mouth closed
      speaking while eating
      nibbling with fingers
    slurping
  eating off of other people's plates
  holding/using utensils properly
Athleticism
Stamina
```

Table 2 is illustrative of the mental parameters used in accordance with one aspect of the present invention.

TABLE 2
Mental Parameters
Mental

Attitude (Broken down into several divisions)
Leader or Follower
Ambition
Confidence (self Image)
Poise
Personality
Knowledge Base
Book smarts
Street smarts
Nimbleness - can think on your feet
Charisma
Believability
Ability to relate to others at different levels
Ability to make small talk
Having friends of all ages/from different backgrounds
Ability to remember others' names
Honesty
Perception of Honesty
Perception of Humility
Humility
Religion
Special Experiences
Intelligence
Educational Base
Specific Subjects
Knowledge of current events
Forgetfulness
Truthfulness
Forgiving
Inquisitive
Conviction
Creative
Open to new ideas
Open to new people
Open to new adventures
Ability to problem solve
Meditation
Focus
Concentration
Good listener
Resolute
Persistent
Sense of Adventure
Flair
Uniqueness
Curiosity
Drive
Determination
Motivation
Grace
Steadfastness
Obstinacy
Stubbornness
Courage
Valor
Generosity
Kindness
Promptness
Simple math - addition, subtraction, percentages
Tipping skills
Reading skills
Reading comprehension
Reading out loud
Consideration of others
Strength of character
Cool under pressure
Cultural
Multi-lingual
Money management
Credit rating
Reaction to wealth
Reaction to poverty
Thoughtfulness
Sense of humor
Ability to tell a joke/funny story
Wittiness
Patience
Prejudice
Tolerance of women (or opposite sex)
Equality for women
Tolerance of same sex (not feeling threatened)
Tolerance of sexual preference other than your own
Laziness
Procrastination
Charitable
Sexual

Table 3 is illustrative of the emotional parameters used in accordance with one aspect of the present invention.

TABLE 3
Emotional Parameters
Emotional

Vulnerability
Sensitivity
Mechanisms of Coping (knowledge of Meditation etc)
Tolerance of foreigners
Tolerance of minorities
Warmth
Hospitable
Empathetic
Sympathetic
Nervousness
Anxiety
Depression
Comforting
Tolerant
Happiness
Anger Control
Love of family
Love of children
Love of pets/animals
Love of music
Love of dance
Jealousy
Passion
Desire
Shyness
Calm
Free-spirited
Arrogance
Overly-excitable
Envy
Love of work (workaholic)
Love of life
Need to consume (“Must have it”)
Lust
Pride
Tender
Sensual
Ability to honestly self-evaluate
Control of risk taking/gambling-not compulsive
Tolerance of non-traditional sexuality
Tolerance of imperfection in others
Tolerance of imperfection in self
Ability to apologize
Fanatical belief
Ability to defer short term pleasure for greater long term benefits
(invest)

The molecular success test can be self-administered. In this embodiment, the user answers the questions based on their self-assessment. The test can also be implemented with by a third party who asks the user questions and enters results based on their interpretation of the user's answers.

The user typically selects a field that they are interested in. The characteristics included in the test, including the physical characteristics, the mental characteristics and the emotional characteristics, can be selected in accordance with the selected field. Thus, one set of characteristics may be deemed important to one field, but not important to another field.

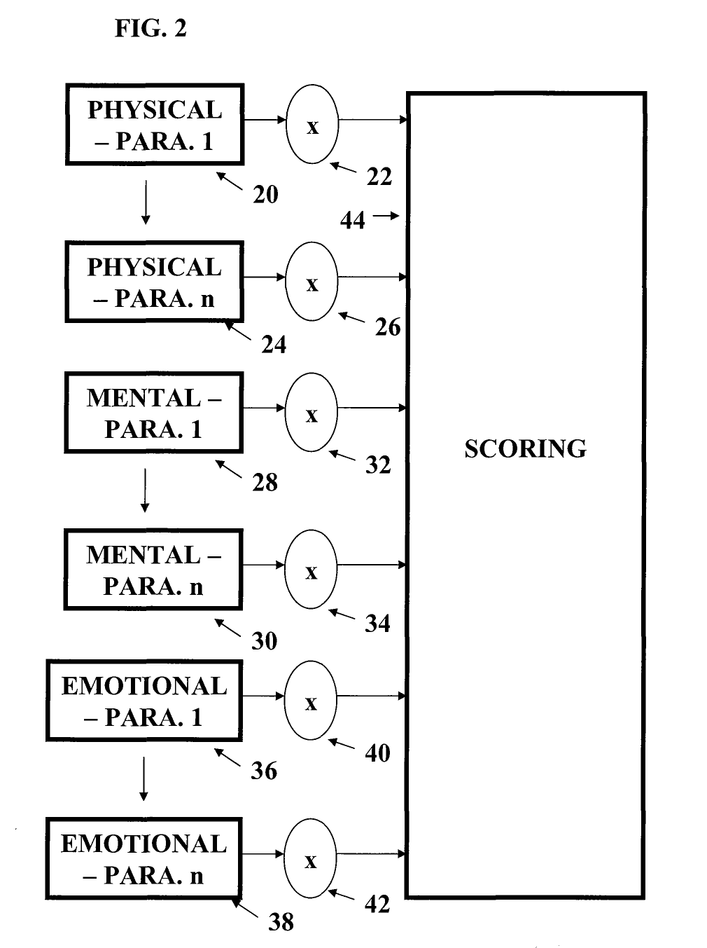

FIG. 2 illustrates the processing of the test to determine a score in accordance with one aspect of the present invention. In steps 20 to 22, the scores associated with the physical characteristics are determined. In steps 24 to 26, these scores are weighted. In steps 28 to 30, the scores associated with the mental characteristics are determined. In steps 32 to 34, these scores are weighted. In steps 36 to 38, the scores associated with the emotional characteristics are determined. In steps 40 to 42, these scores are weighted. In step 44, the weighted scores are input to a processor and a final score determined. The final score can be a simple addition of the weighted scores or any other approach. The weightings used can be any number, including 0 if it is desired to ignore a parameter.

The scores from each of the three main characteristics—physical, mental and emotional—can be summed or processed in any desired way and the weighting can be applied to each score. Then a final score is determined from the weighted physical, mental and emotional scores.

The weightings used can vary depending on the field selected by a user. Thus, a parameter for a model would be weighted differently that a parameter for a lawyer.

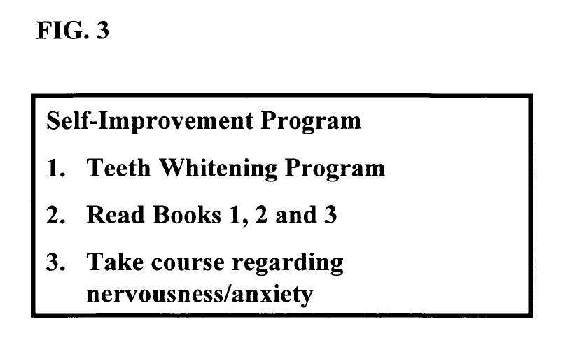

FIG. 3 illustrates a self-improvement plan developed in accordance with a test taken. The self-improvement plan has specific tasks to be accomplished by a user to improve the score on the molecular success test. These tasks are preferably tailored in accordance with the results on the test and with the field selected by the user. Thus, a person that desires to be a model would be given different tasks to work on than a future lawyer. The tasks included in the self-improvement plan are prioritized in accordance with those parameters that will best improve the score. New tasks are included in the self-improvement plan with every round that the molecular success test is taken.

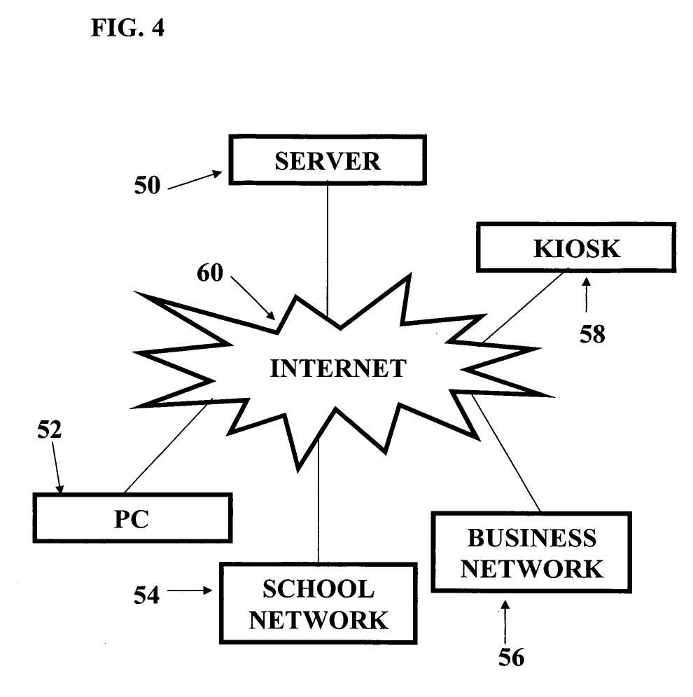

FIG. 4 illustrates a system in accordance with an aspect of the present invention. A server 50 communicates with client computers 52, 54, 56 and 58 via a network 60. The network 60 is preferably the Internet. The computer 52 is a personal computer that can, for example, be located in a person's home or place of business. The computer 54 can be a plurality of computers on a school network. The school can offer students a self-improvement program. The computer 56 can be plurality of computers on a business network. The business, in accordance with one aspect of the present invention, can offer a self-improvement program to its employees. The computer 58 can be in a stand-alone kiosk place in any public place.

In accordance with one aspect of the present invention, the client processors 52, 54, 56 and 58 have computer readable code capable of: providing a test that includes questions that measure a plurality of characteristics of the individual and sending the results of the test to the network. The test may be resident on the client computer or downloaded from the server 50. The server 50 receives the results of the test over the network and has computer readable code capable of: weighting a score associated with each of the measured plurality of characteristics of the individual in accordance with the pre-selected field and determining a final score from the weighted scores, the score being indicative of the chance for success in the pre-selected field.

The server 50 determines the score in accordance with any of the various weighting approaches described herein. The server 50 also generates the improvement program described generally in FIG. 3.

The system and process of the present invention can also be implemented in a stand-alone personal computer or any other type of computer. In this case the computer code that implements all of these functions is located on one computer.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. A method of assessing an individual, comprising:
selecting a preselected field from a plurality of preselected fields;
taking a test, the test including questions that measures one or more physical characteristics of the individual, one or more mental characteristics of the individual and one or more emotional characteristics of the individual;
weighting a score associated with each of the measured characteristics of the individual, the weightings of the score being determined in accordance with the pre-selected field;
determining a final score from the weighted scores, the score being indicative of the chance for success in the preselected field; and
developing a self-improvement plan on a computer based on the score associated with the characteristics of the individual including the one or more physical characteristics of the individual, the one or more mental characteristics of the individual and the one or more emotional characteristics of the individual and on the final score.

2.-4. (canceled)

5. The method of claim 1, wherein weights used during the weighting steps are determined in accordance with the pre-selected field.

6. The method of claim 1, wherein the physical characteristics are selected from the group consisting of: Weight, Height, Torso shape, Face shape, Ears and nose size, Head size, Hair style, Hair length, Hair color, Comb-over, Facial Hair, Color of Eyes, Shape of eyes, Appearance, Skin condition, Facial imperfections, Make-up, Five o'clock shadow, Tan, Body odor, Fragrance, Dress, Fashion sense, Use of color, Fashion color, Fashion fit, Clothing neatness/cleanliness, Appropriate clothing/dress for situation, Appropriate fit, Shoes, Personal accessories, Jewelry/watch, Business accessories, Briefcase, Pen, Best colors for skin and hair tone, Tooth health, Breath, Teeth whiteness, Smile, Best smile, Best profile, Hands—size and skin, Nails well groomed, Bitten nails, Speech (articulation), Speech (modulation), Grammar, Vocabulary, Listening skills, Eye contact, Firm Handshake, Mannerisms, Business Manners, Personal Manners, Sex Appeal, Physical Fitness, Controlled Breathing, Toned, Health, Dependence on medication, Use of vitamins and supplements, Appearance of Health, Financial Stability, Cultural Background, Educational Background, Previous work experience, Wearing Glasses, Style of glasses, Stride, Walking rhythm, Ability to cut across religious backgrounds, Race, Creed, Diet, Nutrition, Alcohol usage, Drug usage, Smoking, Posture, Sitting position, Foot position, Leg crossing, First impression on others, “Tells”—nervous habits, Strength, Physical, Speech, Note taker, Book reader, legible handwriting, Moist skin, Photogenic, Ability with electronics, Phone manner, Gum chewing, Email style, Business presentation skills, Public speaking skills/style, Swearing, Racial/ethnic slurs, Eating habits, Athleticism, and Stamina.

7. The method of claim 1, wherein the mental characteristics are selected from the group consisting of: Attitude, Leader or Follower, Ambition, Confidence (self Image), Poise, Personality, Knowledge Base. Book smarts, Street smarts, Nimbleness, Charisma. Believability, Ability to relate to others at different levels, Ability to make small talk, Having friends of all ages/from different backgrounds, Ability to remember others' names, Honesty, Perception of Honesty, Perception of Humility, Humility, Religion, Special Experiences, Intelligence, Educational Base, Specific Subjects, Knowledge of current events, Forgetfulness, Truthfulness, Forgiving, Inquisitive, Conviction, Creative, Open to new ideas, Open to new people, Open to new adventures, Ability to problem solve, Meditation, Focus, Concentration, Good listener, Resolute, Persistent, Sense of Adventure, Flair, Uniqueness, Curiosity, Drive, Determination, Motivation, Grace, Steadfastness, Obstinacy, Stubbornness, Courage, Valor, Generosity, Kindness, Promptness, Simple math, Tipping skills, Reading skills, Reading comprehension, Reading out loud, Consideration of others, Strength of character, Cool under pressure, Cultural, Multi-lingual, Money management, Credit rating, Reaction to wealth, Reaction to poverty, Thoughtfulness, Sense of humor, Ability to tell a joke/funny story, Wittiness, Patience, Prejudice, Tolerance of women (or opposite sex), Equality for women, Tolerance of same sex (not feeling threatened), Tolerance of sexual preference other than your own, Laziness, Procrastination, Charitable, and Sexual.

8. The method of claim 1, wherein the emotional characteristics are selected from the group consisting of: Vulnerability, Sensitivity, Mechanisms of Coping, knowledge of Meditation, Tolerance of foreigners, Tolerance of minorities, Warmth, Hospitable, Empathetic, Sympathetic, Nervousness, Anxiety, Depression, Comforting, Tolerant, Happiness, Anger Control, Love of family, Love of children, Love of pets/animals, Love of music, Love of dance, Jealousy, Passion, Desire, Shyness, Calm, Free-spirited, Arrogance. Overly-excitable, Envy, Love of work (workaholic), Love of life, Need to consume, Lust, Pride, Tender, Sensual, Ability to honestly self-evaluate, Control of risk taking/gambling-not compulsive, Tolerance of non-traditional sexuality, Tolerance of imperfection in others, Tolerance of imperfection in self, Ability to apologize, Fanatical belief, and Ability to defer short term pleasure for greater long term benefits.

9.-10. (canceled)

11. A system of assessing an individual, comprising:
a network;
a client computer connected to the network, each of the client processors having computer readable code capable of:
allowing a user to select a preselected field from a plurality of preselected fields;
providing a test that includes questions that measure one or more physical characteristics of the individual, one or more mental characteristics of the individual and one or more emotional characteristics of the individual;
sending the results of the test to the network; and
a server connected to the network that receives the results of the test over the network, the server having computer readable code capable of:
weighting a score associated with each of the measured plurality of characteristics of the individual, the weighting of the score being determined in accordance with the pre-selected field;
determining a final score from the weighted scores, the score being indicative of the chance for success in the preselected field; and
developing a self-improvement plan on a computer based on the score associated with the characteristics of the individual including the one or more physical characteristics of the individual, the one or more mental characteristics of the individual and the one or more emotional characteristics of the individual and on the final score.

12.-14. (canceled)

15. The system of claim 11, wherein weights used when weighting scores are determined in accordance with the pre-selected field.

16. The system of claim 11, wherein the physical characteristics are selected from the group consisting of: Weight, Height, Torso shape, Face shape, Ears and nose size, Head size, Hair style, Hair length, Hair color, Comb-over, Facial Hair, Color of Eyes, Shape of eyes, Appearance, Skin condition, Facial imperfections, Make-up, Five o'clock shadow, Tan, Body odor, Fragrance, Dress, Fashion sense, Use of color, Fashion color, Fashion fit, Clothing neatness/cleanliness, Appropriate clothing/dress for situation, Appropriate fit, Shoes, Personal accessories, Jewelry/watch, Business accessories, Briefcase, Pen, Best colors for skin and hair tone, Tooth health, Breath, Teeth whiteness, Smile, Best smile, Best profile, Hands—size and skin, Nails well groomed, Bitten nails, Speech (articulation), Speech (modulation), Grammar, Vocabulary, Listening skills, Eye contact, Firm Handshake, Mannerisms, Business Manners, Personal Manners, Sex Appeal, Physical Fitness, Controlled Breathing, Toned, Health, Dependence on medication, Use of vitamins and supplements, Appearance of Health, Financial Stability, Cultural Background, Educational Background, Previous work experience, Wearing Glasses, Style of glasses, Stride, Walking rhythm, Ability to cut across religious backgrounds, Race, Creed, Diet, Nutrition, Alcohol usage, Drug usage, Smoking, Posture, Sitting position, Foot position, Leg crossing, First impression on others, “Tells”—nervous habits, Strength, Physical, Speech, Note taker, Book reader, legible handwriting, Moist skin, Photogenic, Ability with electronics, Phone manner, Gum chewing, Email style, Business presentation skills, Public speaking skills/style, Swearing, Racial/ethnic slurs, Eating habits, Athleticism, and Stamina.

17. The system of claim 11, wherein the mental characteristics are selected from the group consisting of: Attitude, Leader or Follower, Ambition, Confidence (self Image), Poise, Personality, Knowledge Base. Book smarts, Street smarts, Nimbleness, Charisma. Believability, Ability to relate to others at different levels, Ability to make small talk, Having friends of all ages/from different backgrounds, Ability to remember others' names, Honesty, Perception of Honesty, Perception of Humility, Humility, Religion, Special Experiences, Intelligence, Educational Base, Specific Subjects, Knowledge of current events, Forgetfulness, Truthfulness, Forgiving, Inquisitive, Conviction, Creative, Open to new ideas, Open to new people, Open to new adventures, Ability to problem solve, Meditation, Focus, Concentration, Good listener, Resolute, Persistent, Sense of Adventure, Flair, Uniqueness, Curiosity, Drive, Determination, Motivation, Grace, Steadfastness, Obstinacy, Stubbornness, Courage, Valor, Generosity, Kindness, Promptness, Simple math, Tipping skills, Reading skills, Reading comprehension, Reading out loud, Consideration of others, Strength of character, Cool under pressure, Cultural, Multi-lingual, Money management, Credit rating, Reaction to wealth, Reaction to poverty, Thoughtfulness, Sense of humor, Ability to tell a joke/funny story, Wittiness, Patience, Prejudice, Tolerance of women (or opposite sex), Equality for women, Tolerance of same sex (not feeling threatened), Tolerance of sexual preference other than your own, Laziness, Procrastination, Charitable, and Sexual.

18. The system of claim 11, wherein the emotional characteristics are selected from the group consisting of: Vulnerability, Sensitivity, Mechanisms of Coping, knowledge of Meditation, Tolerance of foreigners, Tolerance of minorities, Warmth, Hospitable, Empathetic, Sympathetic, Nervousness, Anxiety, Depression, Comforting, Tolerant, Happiness, Anger Control, Love of family, Love of children, Love of pets/animals, Love of music, Love of dance, Jealousy, Passion, Desire, Shyness, Calm, Free-spirited, Arrogance. Overly-excitable, Envy, Love of work (workaholic), Love of life, Need to consume, Lust, Pride, Tender, Sensual, Ability to honestly self-evaluate, Control of risk taking/gambling-not compulsive, Tolerance of non-traditional sexuality, Tolerance of imperfection in others, Tolerance of imperfection in self, Ability to apologize, Fanatical belief, and Ability to defer short term pleasure for greater long term benefits.

19.-29. (canceled)
